(19) United States
(12) Patent Application Publication
(10) Pub. No.: US 2002/0004566 A1
(43) Pub. Date: Jan. 10, 2002

(54) Process for the polymerization of olefins; novel polyolefins, and films and articles produced therefrom

(76) Inventors: Randal Ray Ford, Longview, TX (US); Richard Kingsley Stuart JR., Longview, TX (US)

Correspondence Address: Jonathan D. Wood, Eastman Chemical Company, P.O. Box 511, Kingsport, TN, 37662-5075, US

(21) Appl. No.: 09/935,299

(22) Filed: Aug. 22, 2001

Related U.S. Application Data
(63) Continuation of application No. 09/386,546, filed on Aug. 31, 1999.
(60) Provisional application No. 60/141,141, filed on Jun. 25, 1999.

(51) Int. Cl. C08F 4/40

(52) U.S. Cl. 526/91; 526/92; 526/95; 526/96; 526/139; 526/140; 526/141; 526/220; 526/221; 526/222; 526/227; 526/229; 526/160; 526/901; 526/348.4; 526/348.5; 526/348.6

(57) ABSTRACT

A novel process for the polymerization of olefins is provided. The process involves contacting at least one olefin with at least one metallocene catalyst in the presence of a specified compound that results in the production of polymeric products having a narrower molecular weight distribution. Also provided is a process for narrowing the molecular weight distribution of a polyolefin comprising contacting an olefin, at least one metallocene catalyst and a compound specified herein. Further provided are novel polyolefins, and films and articles produced therefrom.

### CROSS-REFERENCE TO RELATED APPLICATION

This application claims priority under 35 U.S.C. §119(e) to U.S. Provisional Application Serial No. 60/141,141, filed Jun. 25, 1999.

### FIELD OF INVENTION

The present invention relates to a process utilizing a metallocene catalyst for the polymerization of olefins having narrowed molecular weight distribution (MWD) values. Additionally, this invention relates to novel polyolefins, and films and articles of manufacture produced therefrom.

### BACKGROUND OF INVENTION

Polyolefins are well known in the art. For example polyethylene and interpolymers of ethylene are well known and are useful in many applications. In particular interpolymers of ethylene, also known as copolymers, terpolymers, and the like of ethylene, possess properties which distinguish them from other polyethylene polymers, such as branched ethylene homopolymers commonly referred to as LDPE (low density polyethylene). Certain of these properties are described by Anderson et al, U.S. Pat. No. 4,076,698.

A particularly useful polymerization medium for producing polymers and interpolymers of olefins such as ethylene is a gas phase process. Examples of such are given in U.S. Pat. Nos. 3,709,853; 4,003,712; 4,011,382; 4,302,566; 4,543,399; 4,882,400; 5,352,749 and 5,541,270 and Canadian Patent No. 991,798 and Belgian Patent No. 839,380.

Metallocene catalysts are known for polymerizing and interpolymerizing olefins such as ethylene. Metallocene catalysts comprise at least one transition metal component having at least one moiety selected from substituted or unsubstituted cyclopentadienyl, substituted or unsubstituted pentadienyl, substituted or unsubstituted pyrrole, substituted or unsubstituted phosphole, substituted or unsubstituted arsole, substituted or unsubstituted boratabenzene, and substituted or unsubstituted carborane, and at least one co-catalyst component. Typical organometallic co-catalysts are alkyl aluminoxanes, such as methyl aluminoxane, and boron containing compounds such as tris(perfluorophenyl)boron and salts of tetrakis(perfluorophenyl)borate.

The metallocene catalysts can be supported on an inert porous particulate carrier.

### SUMMARY OF THE INVENTION

The process of the present invention comprises polymerizing at least one olefin in the presence of at least one metallocene catalyst comprising at least one transition metal component having at least one moiety selected from substituted or unsubstituted cyclopentadienyl, substituted or unsubstituted pentadienyl, substituted or unsubstituted pyrrole, substituted or unsubstituted phosphole, substituted or unsubstituted arsole, substituted or unsubstituted boratabenzene, and substituted or unsubstituted carborane, and at least one co-catalyst component, and a sufficient amount of at least one specified compound to obtain an olefin homopolymer or interpolymer having a narrower molecular weight distribution than an olefin homopolymer or interpolymer having a molecular weight distribution greater than two obtained in the absence of the added compound. The specified compound added to the polymerization process is selected from the following:

1) An oxide of germanium, tin and lead;

2) Cyanogen (C₂N₂);

3) An oxide or imide of carbon of formula CE or C₃E₂ where E=O and NR, R is hydrogen, a halogen, an alkyl group containing up to 50 non-hydrogen atoms, an aryl group containing up to 50 non-hydrogen atoms, a silyl group containing up to 50 non-hydrogen atoms, an alkoxy group containing up to 50 non-hydrogen atoms, an amino group containing up to 50 non-hydrogen atoms, a thiolato group containing up to 50 non-hydrogen atoms, or a boryl group containing up to 50 non-hydrogen atoms;

4) A sulfur, selenium, or tellurium containing chalcogenide of carbon, silicon, germanium, tin and lead;

5) A chalcogenide of carbon, silicon, germanium, tin and lead containing more than one chalcogen;

6) A chalcogenide imide of carbon, silicon, germanium, tin and lead having the formula C(E)(X) where E=O, S, Se, Te, or NR; X=NR′ where R and/or R′ is hydrogen, a halogen, an alkyl group containing up to 50 non-hydrogen atoms, an aryl group containing up to 50 non-hydrogen atoms, a silyl group containing up to 50 non-hydrogen atoms, or a boryl group containing up to 50 non-hydrogen atoms;

7) A chalcogenyl halide or imidohalide of carbon, silicon, germanium, tin and lead of the formula C(E)X₂ where E=O, S, Se, Te, and NR;

R is hydrogen, a halogen, an alkyl group containing up to 50 non-hydrogen atoms, an aryl group containing up to 50 non-hydrogen atoms, a silyl group containing up to 50 non-hydrogen atoms, or a boryl group containing up to 50 non-hydrogen atoms; and X is a halogen;

8) An elemental form of phosphorus, arsenic, antimony and bismuth;

9) An oxide of nitrogen, phosphorus, arsenic, antimony and bismuth;

10) A nitrogen oxoacid or salt containing the anion thereof;

11) A halide of the formula EₙXₘ, where E is nitrogen, phosphorus, arsenic, antimony or bismuth and X is a halogen or pseudohalogen, n=1 to 10, and m=1 to 20;

12) A chalcogenide or imide of nitrogen, phosphorus, arsenic, antimony and bismuth of the general formula EₙYₘ, where E=N, P, As, Sb, and Bi; Y=S, Se, Te, Po and NR; n=1 to 10; m=1 to 40; and R is hydrogen, a halogen, an alkyl group containing up to 50 non-hydrogen atoms, an aryl group containing up to 50 non-hydrogen atoms, a silyl group containing up to 50 non-hydrogen atoms, or a boryl group containing up to 50 non-hydrogen atoms;

13) A chalcogenyl or imido compound of nitrogen, phosphorus, arsenic, antimony and bismuth having the formula EₙYₘX_{q}, where E=N, P, As, Sb and Bi; Y=O, S, Se, Te and NR; X is hydrogen, a halogen, an alkyl group containing up to 50 non-hydrogen atoms, an aryl group containing up to 50 non-hydrogen atoms, a silyl group containing up to 50 non-hydrogen atoms, an alkoxy group containing up to 50 non-hydrogen atoms, an amino group containing up to 50 non-hydrogen atoms, a thiolato group containing up to 50 non-hydrogen atoms, or a boryl group containing up to 50 non-hydrogen atoms; n=1 to 20; m=1 to 40; q=1 to 40; and R is hydrogen, a halogen, an alkyl group containing up to 50 non-hydrogen atoms, an aryl group containing up to 50 non-hydrogen atoms, a silyl group containing up to 50 non-hydrogen atoms, an alkoxy group containing up to 50 non-hydrogen atoms, an amino group containing up to 50 non-hydrogen atoms, a thiolato group containing up to 50 non-hydrogen atoms, or a boryl group containing up to 50 non-hydrogen atoms;

14) An interpnictogen;

15) A phosphazene of the general formula (NPR₂)ₓ, wherein R=halogen, or alkyl or aryl group containing up to 50 non-hydrogen atoms, and x is at least 2;

16) A compound of the general formula A(E)X₃ where A=P, As, Sb, and Bi; E=NR or CR₂, R is hydrogen, a halogen, an alkyl group containing up to 50 non-hydrogen atoms, an aryl group containing up to 50 non-hydrogen atoms, a silyl group containing up to 50 non-hydrogen atoms, an alkoxy group containing up to 50 non-hydrogen atoms, an amino group containing up to 50 non-hydrogen atoms, a thiolato group containing up to 50 non-hydrogen atoms, or a boryl group containing up to 50 non-hydrogen atoms; and X is hydrogen, a halogen, an alkyl group containing up to 50 non-hydrogen atoms, an aryl group containing up to 50 non-hydrogen atoms, a silyl group containing up to 50 non-hydrogen atoms, an alkoxy group containing up to 50 non-hydrogen atoms, an amino group containing up to 50 non-hydrogen atoms, a thiolato group containing up to 50 non-hydrogen atoms, or a boryl group containing up to 50 non-hydrogen atoms;

17) A pnictogen hydride;

18) An elemental form of oxygen, sulfur, selenium, and tellurium;

19) An interchalcogen;

20) A compound containing one or more chalcogens and one or more halogens of formula EnXm where E=O, S, Se, and Te; X is hydrogen, a halogen, an alkyl group containing up to 50 non-hydrogen atoms, an aryl group containing up to 50 non-hydrogen atoms, a silyl group containing up to 50 non-hydrogen atoms, an alkoxy group containing up to 50 non-hydrogen atoms, an amino group containing up to 50 non-hydrogen atoms, a thiolato group containing up to 50 non-hydrogen atoms, or a boryl group containing up to 50 non-hydrogen atoms, n=1 to 10, m=1 to 20;

21) A compound of general formula EOX₂ where E=O, S, Se, and Te; X is hydrogen, a halogen, an alkyl group containing up to 50 non-hydrogen atoms, an aryl group containing up to 50 non-hydrogen atoms, a silyl group containing up to 50 non-hydrogen atoms, an alkoxy group containing up to 50 non-hydrogen atoms, an amino group containing up to 50 non-hydrogen atoms, a thiolato group containing up to 50 non-hydrogen atoms, or a boryl group containing up to 50 non-hydrogen atoms;

22) A compound of general formula EOX₄ where E=S, Se, and Te; X is hydrogen, a halogen, an alkyl group containing up to 50 non-hydrogen atoms, an aryl group containing up to 50 non-hydrogen atoms, a silyl group containing up to 50 non-hydrogen atoms, an alkoxy group containing up to 50 non-hydrogen atoms, an amino group containing up to 50 non-hydrogen atoms, a thiolato group containing up to 50 non-hydrogen atoms, or a boryl group containing up to 50 non-hydrogen atoms;

23) A compound of general formula EO_{z}X₂ where E=S, Se, and Te; X is hydrogen, a halogen, an alkyl group containing up to 50 non-hydrogen atoms, an aryl group containing up to 50 non-hydrogen atoms, a silyl group containing up to 50 non-hydrogen atoms, an alkoxy group containing up to 50 non-hydrogen atoms, an amino group containing up to 50 non-hydrogen atoms, a thiolato group containing up to 50 non-hydrogen atoms, or a boryl group containing up to 50 non-hydrogen atoms;

24) A Sulfur-Nitrogen compound;

25) A compound of the formula S(NR)ₙXₘ where n=1 to 3; m=0 to 6; X is hydrogen, a halogen, an alkyl group containing up to 50 non-hydrogen atoms, an aryl group containing up to 50 non-hydrogen atoms, a silyl group containing up to 50 non-hydrogen atoms, an alkoxy group containing up to 50 non-hydrogen atoms, an amino group containing up to 50 non-hydrogen atoms, a thiolato group containing up to 50 non-hydrogen atoms, or a boryl group containing up to 50 non-hydrogen atoms; and R is hydrogen, a halogen, an alkyl group containing up to 50 non-hydrogen atoms, an aryl group containing up to 50 non-hydrogen atoms, a silyl group containing up to 50 non-hydrogen atoms, an alkoxy group containing up to 50 non-hydrogen atoms, an amino group containing up to 50 non-hydrogen atoms, a thiolato group containing up to 50 non-hydrogen atoms, or a boryl group containing up to 50 non-hydrogen atoms;

26) A sulfur oxoacid, peroxoacid, and salts containing the anions thereof;

27) A selenium oxoacid, peroxoacid, and salts containing the anions thereof;

28) A tellurium oxoacid, peroxoacid, and salts containing the anions thereof;

29) A chalcogen hydride;

30) An elemental form of fluorine, chlorine, bromine, iodine, and astatine;

31) An interhalogen, salts containing their cations, and salts containing the anions thereof;

32) A salt containing polyhalide cations and/or anions;

33) A homoleptic or heteroleptic halogen oxide, salts containing the cations thereof, and salts containing the anion thereof;

34) An oxoacid and salts containing the anions thereof;

35) A hydrogen halide;

36) NH₄F, SF₄, SbF₃, AgF₂, KHF₂, ZnF₂, AsF₃, and salts containing the HF₂⁻ anion;

37) A hydrohalic acid;

38) A He, Ne, Ar, Kr, Xe, and Rn oxide, salts containing the cations thereof, and salts containing the anions thereof;

39) A He, Ne, Ar, Kr, Xe, and Rn halide, salts containing the cations thereof, and salts containing the anions thereof;

40) A He, Ne, Ar, Kr, Xe, and Rn chalcogenyl halide, salts containing the cations thereof, and salts containing the anions thereof;

41) A product obtained by reacting a material selected from the group consisting of water, alcohol, hydrogen sulfide and a thiol with any of the above compounds and salts thereof containing the corresponding anion;

42) An organic peroxide;

43) Water; and

44) Mixtures thereof.

Also provided is a process for narrowing molecular weight distribution of a polymer comprising at least one or more olefin(s) comprising contacting under polymerization conditions, at least one or more olefin(s) with at least one metallocene catalyst comprising at least one transition metal component having at least one moiety selected from substituted or unsubstituted cyclopentadienyl, substituted or unsubstituted pentadienyl, substituted or unsubstituted pyrrole, substituted or unsubstituted phosphole, substituted or unsubstituted arsole, substituted or unsubstituted boratabenzene, and substituted or unsubstituted carborane, and at least one co-catalyst component, and at least one of the specified compounds, wherein the specified compound is present in an amount sufficient that the molecular weight distribution of the resulting polymeric product is narrower than would be obtained in the absence of the specified compound. The specified are listed hereinabove.

All mention herein to elements of Groups of the Periodic Table are made in reference to the Periodic Table of the Elements, as published in “Chemical and Engineering News”, 63(5), 27, 1985. In this format, the Groups are numbered 1 to 18.

In carrying out the novel polymerization process of the present invention, there may optionally be added any electron donor(s) and/or any halogenated hydrocarbon compound(s).

Also, the present invention comprises novel polyolefin hompolymers and copolymers. Further, the present invention comprises films and articles of manufacture produced from the novel polyolefin hompolymers and copolymers.

### DETAILED DESCRIPTION OF THE INVENTION

The present invention relates to a process for polymerizing at least one olefin in the presence of at least one metallocene catalyst comprising at least one transition metal component having at least one moiety selected from substituted or unsubstituted cyclopentadienyl, substituted or unsubstituted pentadienyl, substituted or unsubstituted pyrrole, substituted or unsubstituted phosphole, substituted or unsubstituted arsole, substituted or unsubstituted boratabenzene, and substituted or unsubstituted carborane, and at least one co-catalyst component, and a sufficient amount of at least one specified compound to obtain a polyolefin homopolymer or copolymer characterized by having a molecular weight distribution (MWD) narrower than an olefin homopolymer or interpolymer having a molecular weight distribution greater than two obtained in the absence of the added compound.

Also provided is a process for narrowing molecular weight distribution of a polymer comprising at least one or more olefin(s) comprising contacting under polymerization conditions, at least one or more olefin(s) with at least one metallocene catalyst comprising at least one transition metal component having at least one moiety selected from substituted or unsubstituted cyclopentadienyl, substituted or unsubstituted pentadienyl, substituted or unsubstituted pyrrole, substituted or unsubstituted phosphole, substituted or unsubstituted arsole, substituted or unsubstituted boratabenzene, and substituted or unsubstituted carborane, and at least one co-catalyst component, and at least one of the specified compounds, wherein the specified compound is present in an amount sufficient that the molecular weight distribution of the resulting polymeric product is narrower than would be obtained in the absence of the specified compound. The specified are listed hereinabove.

The polymerization of the at least one olefin herein may be carried out using any suitable process. For example, there may be utilized polymerization in suspension, in solution or in the gas phase media. All of these polymerization processes are well known in the art.

A particularly desirable method for producing polyethylene polymers according to the present invention is a gas phase polymerization process. This type process and means for operating the polymerization reactor are well known and completely described in U.S. Pat Nos. 3,709,853; 4,003.712; 4,011,382; 4,012,573; 4,302,566; 4,543,399; 4,882,400; 5,352,749; 5,541,270; Canadian Patent No. 991,798 and Belgian Patent No. 839,380. These patents disclose gas phase polymerization processes wherein the polymerization zone is either mechanically agitated or fluidized by the continuous flow of the gaseous monomer and diluent. The entire contents of these patents are incorporated herein by reference.

In general, the polymerization process of the present invention may be effected as a continuous gas phase process such as a fluid bed process. A fluid bed reactor for use in the process of the present invention typically comprises a reaction zone and a so-called velocity reduction zone. The reaction zone comprises a bed of growing polymer particles, formed polymer particles and a minor amount of catalyst particles fluidized by the continuous flow of the gaseous monomer and diluent to remove heat of polymerization through the reaction zone. Optionally, some of the recirculated gases may be cooled and compressed to form liquids that increase the heat removal capacity of the circulating gas stream when readmitted to the reaction zone. A suitable rate of gas flow may be readily determined by simple experiment. Make up of gaseous monomer to the circulating gas stream is at a rate equal to the rate at which particulate polymer product and monomer associated therewith is withdrawn from the reactor and the composition of the gas passing through the reactor is adjusted to maintain an essentially steady state gaseous composition within the reaction zone. The gas leaving the reaction zone is passed to the velocity reduction zone where entrained particles are removed. Finer entrained particles and dust may be removed in a cyclone and/or fine filter. The gas is passed through a heat exchanger wherein the heat of polymerization is removed, compressed in a compressor and then returned to the reaction zone.

In more detail, the reactor temperature of the fluid bed process herein ranges from about 30° C. to about 150° C. In general, the reactor temperature is operated at the highest temperature that is feasible taking into account the sintering temperatures of the polymer product within the reactor.

The process of the present invention is suitable for the polymerization of at least one or more olefins. The olefins, for example, may contain from 2 to 16 carbon atoms. Included herein are homopolymers, copolymers, terpolymers, and the like of the olefin monomeric units. Particularly preferred for preparation herein by the process of the present invention are polyethylenes. Such polyethylenes are defined as homopolymers of ethylene and interpolymers of ethylene and at least one alpha-olefin wherein the ethylene content is at least about 50% by weight of the total monomers involved. Exemplary alpha-olefins that may be utilized herein are propylene, 1-butene, 1-pentene, 1-hexene, 1-octene, 4-methyl-1-pentene, 1-decene, 1-dodecene, 1-hexadecene and the like. Also utilizable herein are non-conjugated dienes and olefins formed in situ in the polymerization medium. When olefins are formed in situ in the polymerization medium, the formation of polyethylenes containing long chain branching may occur.

The polymerization reaction of the present invention is carried out in the presence of at least one metallocene catalyst. In the process of the invention, the catalyst can be introduced in any manner known in the art. For example, the catalyst can be introduced directly into the fluidized bed reactor in the form of a solution, a slurry or a dry free flowing powder. The catalyst can also be used in the form of a deactivated catalyst, or in the form of a prepolymer obtained by contacting the catalyst with one or more olefins in the presence of a co-catalyst.

Metallocene catalysts are well known in the industry and are comprised of at least one transition metal component and at least one co-catalyst component. The transition metal component of the metallocene catalyst comprises a compound having at least one moiety selected from substituted or unsubstituted cyclopentadienyl, substituted or unsubstituted pentadienyl, substituted or unsubstituted pyrrole, substituted or unsubstituted phosphole, substituted or unsubstituted arsole, substituted or unsubstituted boratabenzene, and substituted or unsubstituted carborane, and at least one transition metal. Preferably the moiety is a substituted or unsubstituted cyclopentadienyl. The transition metal is selected from Groups 3, 4, 5, 6, 7, 8, 9 and 10 of the Periodic Table of the Elements. Exemplary of such transition metals are scandium, titanium, zirconium, hafnium, vanadium, chromium, manganese, iron, cobalt, nickel, and the like, and mixtures thereof. In a preferred embodiment the transition metal is selected from Groups 4, 5 or 6 such as, for example, titanium, zirconium, hafnium, vanadium and chromnium, and in a still further preferred embodiment, the transition metal is titanium or zirconium or mixtures thereof.

The co-catalyst component of the metallocene catalyst can be any compound, or mixtures thereof, that can activate the transition metal component(s)of the metallocene catalyst in olefin polymerization. Typically the co-catalyst is an alkylaluminoxane such as, for example, methylaluminoxane (MAO) and aryl substituted boron containing compounds such as, for example, tris(perfluorophenyl)borane and the salts of tetrakis(perfluorophenyl)borate.

There are many references describing metallocene catalysts in great detail. For example, metallocene catalysts are described in U.S. Pat. Nos. 4,564,647; 4,752,597; 5,106,804; 5,132,380; 5,227,440; 5,296,565; 5,324,800; 5,331,071; 5,332,706; 5,350,723; 5,399,635; 5,466,766; 5,468,702; 5,474,962; 5,578,537 and 5,863,853. The entire contents of these patents are incorporated herein by reference.

The metallocene catalysts herein also include catalyst systems such as [C₅H₅B—OEt]₂ZrCl₂, [C₅H₄CH₂CH₂NMe₂]TiCl₃, [PC₄Me₃Si(Me)_{z}NCMe₃]ZrCl₂, [C₅Me₄Si(Me)₂NCMe₃]TiCl₂, and (C₅H₅)(C₅H₇)ZrCl₂.

The metallocene catalysts herein can be introduced in the process of the present invention in any manner. For example, the catalyst components can be introduced directly into the polymerization medium in the form of a solution, a slurry or a dry free flowing powder. The transition metal component(s) and the co-catalyst component(s) of the metallocene catalyst can be premixed to form an activated catalyst prior to addition to the polymerization medium, or the components can be added separately to the polymerization medium, or the components can be premixed and then contacted with one or more olefins to form a prepolymer and then added to the polymerization medium in prepolymer form. When the catalyst components are premixed prior to introduction into the reactor, any electron donor compound may be added to the catalyst to control the level of activity of the catalyst.

Any or all of the components of the metallocene catalyst can be supported on a carrier. The carrier can be any particulate organic or inorganic material. Preferably the carrier particle size should not be larger than about 200 microns in diameter. The most preferred particle size of the carrier material can be easily established by experiment. Preferably, the carrier should have an average particle size of 5 to 200 microns in diameter, more preferably 10 to 150 microns and most preferably 20 to 100 microns.

Examples of suitable inorganic carriers include metal oxides, metal hydroxides, metal halogenides or other metal salts, such as sulphates, carbonates, phosphates, nitrates and silicates. Exemplary of inorganic carriers suitable for use herein are compounds of metals from Groups 1 and 2 of the Periodic Table of the Elements, such as salts of sodium or potassium and oxides or salts of magnesium or calcium, for instance the chlorides, sulphates, carbonates, phosphates or silicates of sodium, potassium, magnesium or calcium and the oxides or hydroxides of, for instance, magnesium or calcium. Also suitable for use are inorganic oxides such as silica, titania, alumina, zirconia, chromia, boron oxide, silanized silica, silica hydrogels, silica xerogels, silica aerogels, and mixed oxides such as talcs, silica/chromia, silica/chromia/titania, silica/alumina, silica/titania, silica/magnesia, silica/magnesia/titania, aluminum phosphate gels, silica co-gels and the like. The inorganic oxides may contain small amounts of carbonates, nitrates, sulfates and oxides such as Na₂CO₃, K₂CO₃, CaCO₃, MgCO₃, Na₂SO₄, Al₂(SO₄)₃, BaSO₄, KNO₃, Mg(NO₃)₂, Al(NO₃)₃, Na₂O, K₂0 and Li₂O. Carries containing at least one component selected from the group consisting of MgCl₂, SiO₂, Al₂O₃ or mixtures thereof as a main component are preferred.

Examples of suitable organic carriers include polymers such as, for example, polyethylene, polypropylene, interpolymers of ethylene and alpha-olefins, polystyrene, functionalized polystyrene, polyamides and polyesters.

The metallocene catalyst herein may be prepared by any method known in the art. The catalyst can be in the form of a solution, a slurry or a dry free flowing powder. The amount of metallocene catalyst used is that which is sufficient to allow production of the desired amount of the olefin polymer or interpolymer.

In carrying out the polymerization process of the present invention, the cocatalyst(s) is added to the polymerization medium in any amount sufficient to effect production of the desired olefin polymer or interpolymer. It is preferred to utilize the co-catalyst(s) in a molar ratio of co-catalyst(s) to transition metal component(s) of the metallocene catalyst ranging from about 0.5:1 to about 10000:1. In a more preferred embodiment, the molar ratio of co-catalyst(s) to transition metal component(s) ranges from about 0.5:1 to about 1000:1.

Optionally, any organometallic compound(s) may be added to the polymerization medium in addition to the metallocene catalyst herein. The organometallic compounds may be added for many purposes such as catalyst activity modifiers, particle morphology control agents and/or electrostatic charge mediators. Preferred for use herein are organoaluminum compounds such as trialkylaluminums, dialkylaluminum halides, alkylaluminum dihalides and alkylaluminum sesquihalides. Exemplary of such compounds are trimethylaluminum, triethylaluminum, tri-n-propylaluminum, tri-n-butylaluminum, triisobutylaluminum, tri-n-hexylaluminum, triisohexylaluminum, tri-2-methylpentylaluminum, tri-n-octylaluminum, tri-n-decylaluminum, dimethylaluminum chloride, diethylaluminum chloride, dibutylaluminum chloride, diisobutylaluminum chloride, diethylaluminum bromide and diethylaluminum iodide, methylaluminum dichloride, ethylaluminum dichloride, butylaluminum dichloride, isobutylaluminum dichloride, ethylaluminum dibromide and ethylaluminum diiodide, methylaluminum sesquichloride, ethylaluminum sesquichloride, n-butylaluminum sesquichloride, isobutylaluminum sesquichloride, ethylaluminum sesquifluoride, ethylaluminum sesquibromide, ethylaluminum sesquiiodide and mixtures thereof.

The at least one or more organometallic compound(s), if utilized, can be added to the polymerization medium in any manner. For example, the organometallic compound(s) can be introduced directly into the polymerization medium or premixed with the specified compound prior to addition to the polymerization medium. The amount of organometallic compound(s) added to the polymerization medium is any amount that is suitable to achieve the desired purpose. In a preferred embodiment, the molar ratio of organometallic compound(s) to the specified compound ranges from about 100:1 to about 1:1.

The polymerization reaction is carried out in the presence of a specified compound selected from the following. It is essential that the specified compound be utilized in an amount that will be sufficient to result in the production of polyolefins characterized by having a molecular weight distribution narrower than polyolefins having a molecular weight distribution greater than two obtained in the absence of utilizing the specified compound in the specified amount.

The compounds that are used, in amounts effective to narrow the molecular weight distribution (MWD) of the polyolefins of the present process, are as follow:

a) A compound containing an element of Group 14 (carbon, silicon, germanium, tin and lead) selected from the following:

i) An oxide of germanium, tin and lead such as GeO, GeO₂, SnO, SnO₂, PbO, PbO₂, Pb₂O₃ and Pb₃O₄;

ii) Cyanogen (C₂N₂);

iii) An oxide or imide of carbon of formula CE or C₃E₂ where E=O and NR, R is hydrogen, a halogen, an alkyl group containing up to 50 non-hydrogen atoms, an aryl group containing up to 50 non-hydrogen atoms, a silyl group containing up to 50 non-hydrogen atoms, an alkoxy group containing up to 50 non-hydrogen atoms, an amino group containing up to 50 non-hydrogen atoms, a thiolato group containing up to 50 non-hydrogen atoms, or a boryl group containing up to 50 non-hydrogen atoms, such as CO, C₃O₂, CNH, CNF, CNPh, CNMe, CNSiMe₃, CNBEt₂, and CN-cyclohexyl;

iv) A sulfur, selenium, or tellurium containing chalcogenide of carbon, silicon, germanium, tin and lead such as CS, CS₂, CSe, CTe, SiS₂, GeS₂, SnS₂, CSe₂, and CTe₂;

v) A chalcogenide of carbon, silicon, germanium, tin and lead containing more than one chalcogen such as COS, COSe, CSSe, COTe, CSTe, CSeTe;

vi) A chalcogenide imide of carbon, silicon, germanium, tin and lead having the formula C(E)(X) where E=O, S, Se, Te, or NR; X=NR′ where R and/or R′ is hydrogen, a halogen, an alkyl group containing up to 50 non-hydrogen atoms, an aryl group containing up to 50 non-hydrogen atoms, a silyl group containing up to 50 non-hydrogen atoms, or a boryl group containing up to 50 non-hydrogen atoms, such as C(N-cyclohexyl)₂, CO(NMe), CS(NPh), CSe(NCSiMe₃), and CTe(NBEt₂);

vii) A chalcogenyl halide or imidohalide of carbon, silicon, germanium, tin and lead of the formula C(E)X₂ where E=O, S, Se, Te, and NR; R is hydrogen, a halogen, an alkyl group containing up to 50 non-hydrogen atoms, an aryl group containing up to 50 non-hydrogen atoms, a silyl group containing up to 50 non-hydrogen atoms, or a boryl group containing up to 50 non-hydrogen atoms; and X is a halogen, such as COF₂, COCl₂, C₂O₂Cl₂, C₂O₂F₂, GeOCl₂, C(NCMe₃)Cl₂, C(NCl)Br₂, C₂O(NSiMe₃)Cl₂, C₂(N-cyclohexyl)₂Cl₂, Si(NPh)Cl₂, and Ge(NPh)F₂;

b) A pnictogen containing compound (a pnictogen is an element of Group 15) selected from the following:

i) Elemental forms of phosphorus, arsenic, antimony and bismuth;

ii) An oxide of nitrogen, phosphorus, arsenic, antimony and bismuth such as NO, NO₂, N₂O, N₂O₃, N₂O₄, N₂O₅, P₄Oₙ where n=6-10, AsO,

As₄O₆ or As₂O₃, AS₄O₁₀ or As₂O₅, Sb₂O₃, Sb₂O₄, Sb₂O₅, and Bi₂O₃. Preferred for use herein is dinitrogen monoxide (N₂O);

iii) A nitrogen oxoacid or salt containing the anion thereof, such as HNO₂, HNO₃, NO₂⁻, NO₃⁻;

iv) A halide of the formula EₙXₘ, where E is nitrogen, phosphorus, arsenic, antimony or bismuth and X is a halogen or pseudohalogen, n=1 to 10, and m=1 to 20, such as NF₃, N₂F₄, NCl₃, PF₃, PF₅, P₂F₄, PCl₃, PCl₅, P₂Cl₄, PBr₅, AsF₃, AsF₅, AsCl₅, As₂I₂, SbF₃, SbF₅, SbCl₅, BiF₃, BiF₅, BiBr₃, BiI₂, and BiI₃;

v) A chalcogenide or imide of nitrogen, phosphorus, arsenic, antimony and bismuth of the general formula EₙYₘ, where E=N, P, As, Sb, and Bi; Y=S, Se, Te, and NR; n=1 to 10; m=1 to 40; and R is hydrogen, a halogen, an alkyl group containing up to 50 non-hydrogen atoms, an aryl group containing up to 50 non-hydrogen atoms, a silyl group containing up to 50 non-hydrogen atoms, or a boryl group containing up to 50 non-hydrogen atoms, such as P₄S₃, P₄S₅, P₄Se₅, P₄(NCMe₃)ₙ where n=6 to 10, P₄(NPh)ₙ where n=6 to 10, As₄S₃, As₄S₄, As₄S₅, As₄Se₃ and As₄Se₄;

vi) A chalcogenyl or imido compound of nitrogen, phosphorus, arsenic, antimony and bismuth having the formula EₙYₘX_{q}, where E=N, P, As, Sb and Bi; Y=O, S, Se, Te and NR; X is hydrogen, a halogen, an alkyl group containing up to 50 non-hydrogen atoms, an aryl group containing up to 50 non-hydrogen atoms, a silyl group containing up to 50 non-hydrogen atoms, an alkoxy group containing up to 50 non-hydrogen atoms, an amino group containing up to 50 non-hydrogen atoms, a thiolato group containing up to 50 non-hydrogen atoms, or a boryl group containing up to 50 non-hydrogen atoms; n=1 to 20; m=1 to 40; q=1 to 40; and R is hydrogen, a halogen, an alkyl group containing up to 50 non-hydrogen atoms, an aryl group containing up to 50 non-hydrogen atoms, a silyl group containing up to 50 non-hydrogen atoms, an alkoxy group containing up to 50 non-hydrogen atoms, an amino group containing up to 50 non-hydrogen atoms, a thiolato group containing up to 50 non-hydrogen atoms, or a boryl group containing up to 50 non-hydrogen atoms, such as NOF, NOCl, NOBr, F₃NO, POF₃, POCl₃, POBr₃, PSCl₃, PO(OCN)₃, PO(CN)₃, P(NPh)Cl₃, P(NSiMe₃)Cl₃, P(NPh)F₃, P(NPh)Br₃, P(NBEt₂)Cl₃, PSCl₃, AsOF₃, PO₂Cl, P(NCMe₃)₂Cl, P(NCMe₃)₂Me, As₂O₃Cl₄, POCl, P(NCMe₃)Cl, P(NPh)Cl, P(NSiNe₃)Me, PSeCl, BiOCi and SbOCl;

vii) An interpnictogen (compounds containing at least 2 elements of Group 15) such as PN, AsN;

viii) A phosphazene of the general formula (NPR₂)ₓ, wherein R=halogen, or alkyl or aryl group containing up to 50 non-hydrogen atoms, and x is at least 2;

ix) A compound of the general formula A(E)X₃ where A=P, As, Sb, and Bi; E=NR or CR₂, R is hydrogen, a halogen, an alkyl group containing up to 50 non-hydrogen atoms, an aryl group containing up to 50 non-hydrogen atoms, a silyl group containing up to 50 non-hydrogen atoms, an alkoxy group containing up to 50 non-hydrogen atoms, an amino group containing up to 50 non-hydrogen atoms, a thiolato group containing up to 50 non-hydrogen atoms, or a boryl group containing up to 50 non-hydrogen atoms; and X is hydrogen, a halogen, an alkyl group containing up to 50 non-hydrogen atoms, an aryl group containing up to 50 non-hydrogen atoms, a silyl group containing up to 50 non-hydrogen atoms, an alkoxy group containing up to 50 non-hydrogen atoms, an amino group containing up to 50 non-hydrogen atoms, a thiolato group containing up to 50 non-hydrogen atoms, or a boryl group containing up to 50 non-hydrogen atoms, such as P(CH₂)Ph₃, P(CH₂)Me₃, P(CH₂)(OPh)₃, P(CH₂)(NMe₂)₃, P(CHSiMe₃)Me₃, P(CHBEt₂)Me₃, P(CHMe)Ph₃, P(CHPh)Ph₃, P(CHMe)Me₃, P(NCMe₃)Ph₃, P(NPh)Ph₃, P(NSiMe-₃)Me₃, P(NCMe₃)Me₃, P(NCMe₃)Ph₃, P(NCMe₃)Cl₃, P(NCMe-₃)Br₂Me, P(NBPh₂)Cl₃, P(NBPr₂)Et₃, P(NCMe₃)(OCMe₃)₃, As(CHMe)Ph₃, Sb(CHMe)Ph₃, As(NCMe₃)Ph₃;

x) A pnictogen hydride such as H₃N, H₃P, H₃As, H₃Sb, H₃Bi;

c) A chalcogen containing compound (a chalcogen is an element of Group 16) selected from the following:.

i) An elemental form of oxygen, sulfur, selenium, and tellurium such as O₂, O₃, Sₙ where n=1 to 30, Se₂, Se₈, and Te₂. Other allotropes of these elements may also be used;

ii) An interchalcogen (compounds containing at least 2 Group 16 elements) such as SO, SO₂, SO₃, SeO₂ SeO₃, TeO₂, SₙO₂, where n=5 to 8);

iii) A compound containing one or more chalcogens and one or more halogens of formula EₙXₘ, where E=O, S, Se, and Te; X is hydrogen, a halogen, an alkyl group containing up to 50 non-hydrogen atoms, an aryl group containing up to 50 non-hydrogen atoms, a silyl group containing up to 50 non-hydrogen atoms, an alkoxy group containing up to 50 non-hydrogen atoms, an amino group containing up to 50 non-hydrogen atoms, a thiolato group containing up to 50 non-hydrogen atoms, or a boryl group containing up to 50 non-hydrogen atoms, n=1 to 10, m=1 to 20, such as SOCl₂, SO₂Cl₂, SOF₂, Se₂F₂, S₂Cl₂, S₂F₄, S₄Cl₄, S₄F₄, SeBr₂, S₂F₁₀, OF₂, SF₂, SF₄, SF₆, SeF₂, SeF₄, SeF₃, TeF₄, TeF₆, SCl₄, TeI₄ and mixed halides such as SF₅Cl, SF₃Cl, SO₂SbF₅;

iv) A compound of general formula EOX₂ where E=O, S, Se, and Te; X is hydrogen, a halogen, an alkyl group containing up to 50 non-hydrogen atoms, an aryl group containing up to 50 non-hydrogen atoms, a silyl group containing up to 50 non-hydrogen atoms, an alkoxy group containing up to 50 non-hydrogen atoms, an amino group containing up to 50 non-hydrogen atoms, a thiolato group containing up to 50 non-hydrogen atoms, or a boryl group containing up to 50 non-hydrogen atoms, such as SOF₂, SOCl₂, SOBr₂, SOFCl, SeOF₂, SeOCl₂, SeOBr₂ SOMe₂, SO₂Me₂, SO₂Ph₂, SO₂(OEt)₂, SO₂(SPh)₂, and SO(SiMe₃)₂;

v) A compound of general formula EOX₄ where E=S, Se, and Te; X is hydrogen, a halogen, an alkyl group containing up to 50 non-hydrogen atoms, an aryl group containing up to 50 non-hydrogen atoms, a silyl group containing up to 50 non-hydrogen atoms, an alkoxy group containing up to 50 non-hydrogen atoms, an amino group containing up to 50 non-hydrogen atoms, a thiolato group containing up to 50 non-hydrogen atoms, or a boryl group containing up to 50 non-hydrogen atoms, such as SOF₄, SeOF₄, and TeOF₄;

vi) A compound of general formula EO_{z}X₂ where E=S, Se, and Te; X is hydrogen, a halogen, an alkyl group containing up to 50 non-hydrogen atoms, an aryl group containing up to 50 non-hydrogen atoms, a silyl group containing up to 50 non-hydrogen atoms, an alkoxy group containing up to 50 non-hydrogen atoms, an amino group containing up to 50 non-hydrogen atoms, a thiolato group containing up to 50 non-hydrogen atoms, or a boryl group containing up to 50 non-hydrogen atoms, such as SO₂F₂, SO₂Cl₂, SO₂FCl, SO₂FBr, SeO₂F₂;

vii) A Sulfur-Nitrogen compound such as NS, NSCl, S₃N₂Cl₂, S₄N₄, S₄N₃Cl, S₂N₂, S₄N₄H₂, N₄S₄F₄, S₃N₃Cl₃, S₄N₂, NSF, S₇NH, SF₅NF₂, (SN)ₓ, where x is greater than 1;

viii) A compound of the formula S(NR)ₙXₘ where n=1 to 3; m=0 to 6; X is hydrogen, a halogen, an alkyl group containing up to 50 non-hydrogen atoms, an aryl group containing up to 50 non-hydrogen atoms, a silyl group containing up to 50 non-hydrogen atoms, an alkoxy group containing up to 50 non-hydrogen atoms, an amino group containing up to 50 non-hydrogen atoms, a thiolato group containing up to 50 non-hydrogen atoms, or a boryl group containing up to 50 non-hydrogen atoms; and R is hydrogen, a halogen, an alkyl group containing up to 50 non-hydrogen atoms, an aryl group containing up to 50 non-hydrogen atoms, a silyl group containing up to 50 non-hydrogen atoms, an alkoxy group containing up to 50 non-hydrogen atoms, an amino group containing up to 50 non-hydrogen atoms, a thiolato group containing up to 50 non-hydrogen atoms, or a boryl group containing up to 50 non-hydrogen atoms, such as CF₃N=SF₂, RCF₂N=SF₂, S(NSiMe₃)₂, S(NSiMe₃)₃, S(NCMe₃)₂, S(NCMe₃)₃, S(NSO₂—C₆H₄—Me)₂, S(NSO₂—C₆H₄—Me)₃, and S(NCH(CF₃)₂)₃;

ix) A sulfur oxoacid, peroxoacid, and salts containing the anions thereof, such as H₂SO₃, HSO₃⁻, SO₃²⁻, H₂SO₄, HSO₄⁻, SO₄²⁻, H₂S₂O₃, HS₂O₃⁻, S₂O₃²⁻, H₂S₂O₃, HS₂O₃⁻, S₂O₃²⁻, H₂S₂O₄, HS₂O₄⁻, S₂O₄²⁻, H₂S₂O₅, HS₂O₅⁻, S₂O₅²⁻, H₂S₂O₆, HS₂O₆⁻, S₂O₆²⁻, H₂S₂O₇, HS₂O₇, S₂O₇²⁻, H₂Sₙ₊₂O₆ where n is greater than 0, HSₙ₊₂O₆⁻ where n is greater than 0, Sₙ₊₂O₆²⁻where n is greater than 0, H₂SO₅, HSO₅⁻, SO₅²⁻, H₂S₂O₈, HS₂O₈⁻, S₂O₈²⁻;

x) A selenium oxoacid, peroxoacid, and salts containing the anions thereof, such as H₂SeO₃, HSeO₃⁻, SeO₃²⁻, HSeO₃⁻, H₂SeO₄, HSeO₄⁻, SeO₄²⁻;

xi) A tellurium oxoacid, peroxoacid, and salts containing the anions thereof, such as H₂TeO₃, HTeO₃⁻, TeO₃²⁻, H₂TeO₄, HTeO₄⁻, TeO₄²⁻;

xii) A chalcogen hydride, such as SH₂, SeH₂, TeH₂, SOH₂, SeOH₂, and SSeH₂;

d) A halogen containing compound (a halogen is an element of Group 17) selected from the following:

i) Elemental forms of fluorine, chlorine, bromine, iodine, and astatine, such as F₂, Cl₂, Br₂, I₂, and At₂ or any other allotrope;

ii) An interhalogen (compounds containing at least 2 Group 17 elements), salts containing their cations, and salts containing the anions thereof, such as ClF, ClF₃, ClF₅, BrF, BrF₃, BrF₅, IF, IF₃, IF₅, IF₇, BrCl₃, ICl, ICl₃, I₂Cl₆, IF₄⁺, BrF₂⁺, BrF₄⁺, IF₂⁺, IF₆⁺, Cl₂F⁺, ClF₂⁻, ClF₄⁻, BrF₂⁻, BrF₄⁻, BrF₆⁻, IF₂⁻, IF₄⁻, IF₃⁻, IF₆⁻, IF₈⁻²;

iii) A salt containing polyhalide cations and/or anions, such as Br₂⁺, I₂⁺, Cl₃⁺, Br₃⁺, I₃⁺, Cl₃, Br₃, I₃, Br₂Cl⁻, BrCl₂⁻, ICl₄⁻, IBrCl₃⁻, I₂Br₂Cl⁻, I₄Cl⁻, I₅⁺, ICl₂⁺, IBrCl⁺, IBr₂⁺, I₂Cl⁺, I₂Br⁺, I₂Cl⁻, IBr₂, ICl₂⁻, IBCl⁻², IBrF⁻, I₅⁻;

iv) A homoleptic or heteroleptic halogen oxide, salts containing the cations thereof, and salts containing the anion thereof, such as FClO₂, ClO₂⁺, F₂ClO₂⁻, F₃ClO, FClO₃, F₃ClO₂, FBrO₂, FBrO₃, FIO₂, F₃IO, FIO₃, F₃IO₂, F₅IO, ClF₃O, I₂O₄F₅, F₂O, F₂O₂, Cl₂O, ClO₂, Cl₂O₄, Cl₂O₆, Cl₂O₇, Br₂O, Br₃O₈ or BrO₃, BrO₂, I₂O₄, I₄O₉, I₂O₅, Br₂O₃;

v) An oxoacid and salts containing the anions thereof, such as HOF, OF⁻, HOCl, HClO₂⁻, HClO₃, ClO⁻, ClO₂⁻, ClO₃⁻, HBrO, HBrO₂, HBrO₃, HBrO₄, BrO⁻, BrO₂⁻, BrO₃⁻, BrO₄⁻, HIO, HIO₃, HIO₄, IO⁻, IO₃⁻, IO₄⁻, HAtO, HAtO₃, HAtO₄, AtO₃⁻, AtO₄⁻, AtO⁻;

vi) A hydrogen halide, such as HF, HCl, HBr, HI, HAt;

vii) NH₄F, SF₄, SbF₃, AgF₂, KHF₂, ZnF₂, AsF₃, and salts containing the HF₂⁻ anion;

viii) A hydrohalic acid, such as HF_{(aq)}, HCl_{(aq)}, HBr_{(aq)}, HI_{(aq)}, HAt_{(aq)};

e) A noble gas containing compound (a noble gas is an element of Group 18) selected from the following:

i) A He, Ne, Ar, Kr, Xe, and Rn oxide, salts containing the cations thereof, and salts containing the anions thereof, such as XeO₃, XeO₂, XeO₄, XeO₄²⁻, and XeO₆⁴⁻;

ii) A He, Ne, Ar, Kr, Xe, and Rn halide, salts containing the cations thereof, and salts containing the anions thereof, such as KrF₂, XeF₂, XeCl₂, XeF₄, XeF₆, KrF⁺, Kr₂F₃⁺, XeF⁺, XeF₅⁺, Xe₂F₃⁺, XeF₇⁻, XeF₈²⁻, Xe₂F₁₁⁺;

iii) A He, Ne, Ar, Kr, Xe, and Rn chalcogenyl halide, salts containing the cations thereof, and salts containing the anions thereof, such as XeOF₄, XeO₂F₂, XeO₃F₂, XeO₃F⁻, XeOF₃⁺, XeO₂F⁻;

f) A product obtained by reacting a material selected from the group consisting of water, alcohol, hydrogen sulfide and a thiol with any compound selected from a) i-vii; b) i-x; c) i-xii; d) i-viii; e) i-iii; and salts thereof containing the corresponding anion;

g) An organic peroxide;

h) Water; and

i) Mixtures thereof.

When the specified compound is a liquid or solid at 1 atmosphere of pressure and at 20° C., it is preferred to incorporate the specified compound in a molar ratio of specified compound to transition metal component(s) of the metallocene catalyst ranging from about 0.001:1 to about 100:1. In a more preferred embodiment, where the specified compound is a liquid or solid, the molar ratio of the specified compound to transition metal component(s) ranges from about 0.01:1 to about 50:1. When the specified compound is a gas at 1 atmosphere of pressure and at 20° C., it is preferred to incorporate the gaseous compound at a concentration in the polymerization medium ranging from about 1 ppm by volume to about 10,000 ppm by volume. In a more preferred embodiment, the concentration of the gaseous compound in the polymerization medium ranges from about 1 ppm by volume to about 1000 ppm by volume.

In carrying out the polymerization reaction of the present process there may be added other conventional additives generally utilized in processes for polymerizing olefins. Specifically there may be added any halogenated hydrocarbon and/or electron donor(s).

In carrying out the polymerization process of the present invention, the optional halogenated hydrocarbon may be added to the polymerization medium in any amount sufficient to effect production of the desired polyolefin. It is preferred to incorporate the halogenated hydrocarbon in a molar ratio of halogenated hydrocarbon to metal component of the metallocene catalyst ranging from about 0.001:1 to about 100:1. In a more preferred embodiment, the molar ratio of halogenated hydrocarbon to metal component ranges from about 0.001:1 to about 10:1.

There are also provided herein novel polyethylenes. These polyethylenes are homopolymers of ethylene and copolymers of ethylene and at least one or more alpha-olefins having 3 to 16 carbon atoms wherein ethylene comprises at least about 50% by weight of the total monomers involved.

Any conventional additive may be added to the olefin polymers and interpolymers of the present invention. Examples of the additives include nucleating agents, heat stabilizers, antioxidants of phenol type, sulfur type and phosphorus type, lubricants, antistatic agents, dispersants, copper harm inhibitors, neutralizing agents, foaming agents, plasticizers, anti-foaming agents, flame retardants, crosslinking agents, flowability improvers such as peroxides, ultraviolet light absorbers, light stabilizers, weathering stabilizers, weld strength improvers, slip agents, anti-blocking agents, antifogging agents, dyes, pigments, natural oils, synthetic oils, waxes, fillers and rubber ingredients.

The novel polyolefins of the present invention may be fabricated into films by any technique known in the art. For example, films may be produced by the well known cast film, blown film and extrusion coating techniques.

Further, the novel polyolefins may be fabricated into other articles of manufacture, such as molded articles, by any of the well known techniques.

The invention will be more readily understood by reference to the following examples. There are, of course, many other forms of this invention which will become obvious to one skilled in the art, once the invention has been fully disclosed, and it will accordingly be recognized that these examples are given for the purpose of illustration only, and are not to be construed as limiting the scope of this invention in any way.

### EXAMPLES

In the following examples the molecular weight distribution (MWD), the ratio of Mw/Mn, of the olefin polymers and interpolymers is determined with a Waters Gel Permeation Chromatograph Series 150C equipped with Ultrastyrogel columns and a refractive index detector. The operating temperature of the instrument was set at 140° C., the eluting solvent was o-dichlorobenzene, and the calibration standards included 10 polystyrenes of precisely known molecular weight, ranging from a molecular weight of 1000 to a molecular weight of 1.3 million, and a polyethylene standard, NBS 1475.

The polymerization process utilized in Examples 1-12 herein is carried out in a fluidized-bed reactor for gas-phase polymerization, consisting of a vertical cylinder of diameter 0.74 meters and height 7 meters and surmounted by a velocity reduction chamber. The reactor is provided in its lower part with a fluidization grid and with an external line for recycling gas, which connects the top of the velocity reduction chamber to the lower part of the reactor, at a point below the fluidization grid. The recycling line is equipped with a compressor for circulating gas and a heat transfer means such as a heat exchanger. In particular the lines for supplying ethylene, an olefin such as 1-butene, 1-pentene and 1-hexene, hydrogen and nitrogen, which represent the main constituents of the gaseous reaction mixture passing through the fluidized bed, feed into the recycling line. Above the fluidization grid, the reactor contains a fluidized bed consisting of a polyethylene powder made up of particles with a weight-average diameter of about 0.5 mm to about 1.4 mm. The gaseous reaction mixture, which contains ethylene, olefin comonomer, hydrogen, nitrogen and minor amounts of other components, passes through the fluidized bed under a pressure ranging from about 280 psig to about 300 psig with an ascending fluidization speed, referred to herein as fluidization velocity, ranging from about 1.6 feet per second to about 2.0 feet per second.

When a liquid compound is utilized to narrow the molecular weight distribution, the liquid compound is introduced continuously into the line for recycling the gaseous reaction mixture as a solution, for example, in n-hexane, n-pentane, isopentane or 1-hexene, at a concentration of about 1 weight percent.

When a gaseous compound is utilized to narrow the molecular weight distribution, for example, N₂O, the gaseous compound is introduced continuously into the line for recycling the gaseous reaction mixture.

### Example 1

The polymerization process is carried out as described above. The olefins used herein are ethylene and 1-hexene. Hydrogen is used to control molecular weight. The metallocene catalyst comprises bis(1-butyl-3-methylcyclopentadienyl)zirconium dichloride and methylaluminoxane supported on silica. There can be produced an interpolymer having a molecular weight distribution greater than 2.

The molecular weight distribution (MWD) of the ethylene/1-hexene interpolymer is expected to be reduced as a result of incorporating dinitrogen monoxide (N₂O) in the polymerization medium.

### Examples 2-6

The process of Example 1 is followed with the exception that in place of the 1-hexene there is utilized the following comonomers:

Example 2 propylene,

Example 3 1-butene,

Example 4 1-pentene,

Example 5 4-methylpent-1-ene,

Example 6 1-octene.

In each of the above Examples 2-6 the molecular weight distribution of the ethylene/olefin interpolymer having a molecular weight distribution greater than two is expected to be reduced as a result of incorporating the dinitrogen monoxide in the polymerization medium.

### Examples 7-11

The process of Example 1 is followed with the exception that the supported metallocene catalyst is replaced with the following silica supported metallocene catalysts:

Example 7 bis(1-butyl-3-methylcyclopentadienyl)dimethylzirconium and tris(perfluorophenyl)borane,

Example 8 bis(1-butyl-3-methylcyclopentadienyl)dimethylzirconium and triphenylmethylium tetrakis(perfluorophenyl)borate,

Example 9 (tert-butylamido)dimethyl(tetramethyl-η⁵-cyclopentadienyl)silanetitaniumdimethyl and triphenylmethylium tetrakis(perfluorophenyl)borate,

Example 10 (tert-butylamido)dimethyl(tetramethyl-η⁵-cyclopentadienyl)silanetitaniumdimethyl and tris(perfluorophenyl)borane,

Example 11 (tert-butylamido)dimethyl(tetramethylη⁵-cyclopentadienyl)silanetitaniumdimethyl and methylaluminoxane.

In each of the above Examples 7-11 the molecular weight distribution of the ethylene/olefin interpolymer having a molecular weight distribution greater than two is expected to be reduced as a result of incorporating the dinitrogen monoxide in the polymerization medium.

### Example 12

The process of Example 1 is followed with the exception that trimethylaluminum is added, in addition to the metallocene catalyst, to the polymerization process.

Films can be prepared from the ethylene/olefin interpolymers of the present invention.

Articles such as molded items can also be prepared from the ethylene/olefin interpolymers of the present invention.

It should be clearly understood that the forms of the invention herein described are illustrative only and are not intended to limit the scope of the invention. The present invention includes all modifications falling within the scope of the following claims.

We claim:

1. A process for polymerizing at least one or more olefin(s) comprising contacting, under polymerization conditions, the at least one or more olefin(s) with at least one metallocene catalyst comprising at least one transition metal component having at least one moiety selected from substituted or unsubstituted cyclopentadienyl, substituted or unsubstituted pentadienyl, substituted or unsubstituted pyrrole, substituted or unsubstituted phosphole, substituted or unsubstituted arsole, substituted or unsubstituted boratabenzene, and substituted or unsubstituted carborane, and at least one co-catalyst component, and a compound selected from the group consisting of
(a) An oxide of germanium, tin and lead;
(b) Cyanogen (C₂N₂);
(c) An oxide or imide of carbon of formula CE or C₃E₂ where E=O and NR, R is hydrogen, a halogen, an alkyl group containing up to 50 non-hydrogen atoms, an aryl group containing up to 50 non-hydrogen atoms, a silyl group containing up to 50 non-hydrogen atoms, an alkoxy group containing up to 50 non-hydrogen atoms, an amino group containing up to 50 non-hydrogen atoms, a thiolato group containing up to 50 non-hydrogen atoms, or a boryl group containing up to 50 non-hydrogen atoms;
(d) A sulfur, selenium, or tellurium containing chalcogenide of carbon, silicon, germanium, tin and lead;
(e) A chalcogenide of carbon, silicon, germanium, tin and lead containing more than one chalcogen;
(f) A chalcogenide imide of carbon, silicon, germanium, tin and lead having the formula C(E)(X) where E=O, S, Se, Te, or NR; X=NR′ where R and/or R′ is hydrogen, a halogen, an alkyl group containing up to 50 non-hydrogen atoms, an aryl group containing up to 50 non-hydrogen atoms, a silyl group containing up to 50 non-hydrogen atoms, or a boryl group containing up to 50 non-hydrogen atoms;
(g) A chalcogenyl halide or imidohalide of carbon, silicon, germanium, tin and lead of the formula C(E)X₂ where E=O, S, Se, Te, and NR; R is hydrogen, a halogen, an alkyl group containing up to 50 non-hydrogen atoms, an aryl group containing up to 50 non-hydrogen atoms, a silyl group containing up to 50 non-hydrogen atoms, or a boryl group containing up to 50 non-hydrogen atoms; and X is a halogen;
(h) An elemental form of phosphorus, arsenic, antimony and bismuth;
(i) An oxide of nitrogen, phosphorus, arsenic, antimony and bismuth;
(j) A nitrogen oxoacid or salt containing the anion thereof;
(k) A halide of the formula EₙXₘ, where E is nitrogen, phosphorus, arsenic, antimony or bismuth and X is a halogen or pseudohalogen, n=1 to 10, and m=1 to 20;
(l) A chalcogenide or imide of nitrogen, phosphorus, arsenic, antimony and bismuth of the general formula EₙYₘ, where E=N, P, As, Sb, and Bi; Y=S, Se, Te and NR; n=1 to 10; m=1 to 40; and R is hydrogen, a halogen, an alkyl group containing up to 50 non-hydrogen atoms, an aryl group containing up to 50 non-hydrogen atoms, a silyl group containing up to 50 non-hydrogen atoms, or a boryl group containing up to 50 non-hydrogen atoms;
(m) A chalcogenyl or imido compound of nitrogen, phosphorus, arsenic, antimony and bismuth having the formula EₙYₘX_{q}, where E=N, P, As, Sb and Bi; Y=O, S, Se, Te and NR; X is hydrogen, a halogen, an alkyl group containing up to 50 non-hydrogen atoms, an aryl group containing up to 50 non-hydrogen atoms, a silyl group containing up to 50 non-hydrogen atoms, an alkoxy group containing up to 50 non-hydrogen atoms, an amino group containing up to 50 non-hydrogen atoms, a thiolato group containing up to 50 non-hydrogen atoms, or a boryl group containing up to 50 non-hydrogen atoms; n=1 to 20; m=1 to 40; q=1 to 40; and R is hydrogen, a halogen, an alkyl group containing up to 50 non-hydrogen atoms, an aryl group containing up to 50 non-hydrogen atoms, a silyl group containing up to 50 non-hydrogen atoms, an alkoxy group containing up to 50 non-hydrogen atoms, an amino group containing up to 50 non-hydrogen atoms, a thiolato group containing up to 50 non-hydrogen atoms, or a boryl group containing up to 50 non-hydrogen atoms;
(n) An interpnictogen;
(o) A phosphazene of the general formula (NPR₂)ₓ wherein R=halogen, or alkyl or aryl group containing up to 50 non-hydrogen atoms, and x is at least 2;
(p) A compound of the general formula A(E)X₃ where A=P, As, Sb, and Bi; E=NR or CR₂, R is hydrogen, a halogen, an alkyl group containing up to 50 non-hydrogen atoms, an aryl group containing up to 50 non-hydrogen atoms, a silyl group containing up to 50 non-hydrogen atoms, an alkoxy group containing up to 50 non-hydrogen atoms, an amino group containing up to 50 non-hydrogen atoms, a thiolato group containing up to 50 non-hydrogen atoms, or a boryl group containing up to 50 non-hydrogen atoms; and X is hydrogen, a halogen, an alkyl group containing up to 50 non-hydrogen atoms, an aryl group containing up to 50 non-hydrogen atoms, a silyl group containing up to 50 non-hydrogen atoms, an alkoxy group containing up to 50 non-hydrogen atoms, an amino group containing up to 50 non-hydrogen atoms, a thiolato group containing up to 50 non-hydrogen atoms, or a boryl group containing up to 50 non-hydrogen atoms;
(q) A pnictogen hydride;
(r) An elemental form of oxygen, sulfur, selenium, and tellurium;
(s) An interchalcogen;
(t) A compound containing one or more chalcogens and one or more halogens of formula EₙXₘ where E=O, S, Se, and Te; X is hydrogen, a halogen, an alkyl group containing up to 50 non-hydrogen atoms, an aryl group containing up to 50 non-hydrogen atoms, a silyl group containing up to 50 non-hydrogen atoms, an alkoxy group containing up to 50 non-hydrogen atoms, an amino group containing up to 50 non-hydrogen atoms, a thiolato group containing up to 50 non-hydrogen atoms, or a boryl group containing up to 50 non-hydrogen atoms, n=1 to 10, m=1 to 20;
(u) A compound of general formula EOX₂ where E=O, S, Se, and Te; X is hydrogen, a halogen, an alkyl group containing up to 50 non-hydrogen atoms, an aryl group containing up to 50 non-hydrogen atoms, a silyl group containing up to 50 non-hydrogen atoms, an alkoxy group containing up to 50 non-hydrogen atoms, an amino group containing up to 50 non-hydrogen atoms, a thiolato group containing up to 50 non-hydrogen atoms, or a boryl group containing up to 50 non-hydrogen atoms;
(v) A compound of general formula EOX₄ where E=S, Se, and Te; X is hydrogen, a halogen, an alkyl group containing up to 50 non-hydrogen atoms, an aryl group containing up to 50 non-hydrogen atoms, a silyl group containing up to 50 non-hydrogen atoms, an alkoxy group containing up to 50 non-hydrogen atoms, an amino group containing up to 50 non-hydrogen atoms, a thiolato group containing up to 50 non-hydrogen atoms, or a boryl group containing up to 50 non-hydrogen atoms;
(w) A compound of general formula EOX₂ where E=S, Se, and Te; X is hydrogen, a halogen, an alkyl group containing up to 50 non-hydrogen atoms, an aryl group containing up to 50 non-hydrogen atoms, a silyl group containing up to 50 non-hydrogen atoms, an alkoxy group containing up to 50 non-hydrogen atoms, an amino group containing up to 50 non-hydrogen atoms, a thiolato group containing up to 50 non-hydrogen atoms, or a boryl group containing up to 50 non-hydrogen atoms;
(x) A Sulfur-Nitrogen compound;
(y) A compound of the formula S(NR)ₙXₘ where n=1 to 3; m−0 to 6; X is hydrogen, a halogen, an alkyl group containing up to 50 non-hydrogen atoms, an aryl group containing up to 50 non-hydrogen atoms, a silyl group containing up to 50 non-hydrogen atoms, an alkoxy group containing up to 50 non-hydrogen atoms, an amino group containing up to 50 non-hydrogen atoms, a thiolato group containing up to 50 non-hydrogen atoms, or a boryl group containing up to 50 non-hydrogen atoms; and R is hydrogen, a halogen, an alkyl group containing up to 50 non-hydrogen atoms, an aryl group containing up to 50 non-hydrogen atoms, a silyl group containing up to 50 non-hydrogen atoms, an alkoxy group containing up to 50 non-hydrogen atoms, an amino group containing up to 50 non-hydrogen atoms, a thiolato group containing up to 50 non-hydrogen atoms, or a boryl group containing up to 50 non-hydrogen atoms;
(z) A sulfur oxoacid, peroxoacid, and salts containing the anions thereof;
(aa) A selenium oxoacid, peroxoacid, and salts containing the anions thereof;
(bb) A tellurium oxoacid, peroxoacid, and salts containing the anions thereof;
(cc) A chalcogen hydride;
(dd) An elemental form of fluorine, chlorine, bromine, iodine, and astatine;
(ee) An interhalogen, salts containing their cations, and salts containing the anions thereof;
(ff) A salt containing polyhalide cations and/or anions;
(gg) A homoleptic or heteroleptic halogen oxide, salts containing the cations thereof, and salts containing the anion thereof;
(hh) An oxoacid and salts containing the anions thereof;
(ii) A hydrogen halide;
(j) NH₄F, SF₄, SbF₃, AgF₂, KHF₂, ZnF₂, AsF₃, and salts containing the HF₂⁻ anion;
(kk) A hydrohalic acid;
(ll) A He, Ne, Ar, Kr, Xe, and Rn oxide, salts containing the cations thereof, and salts containing the anions thereof;
(mm) A He, Ne, Ar, Kr, Xe, and Rn halide, salts containing the cations thereof, and salts containing the anions thereof;
(nn) A He, Ne, Ar, Kr, Xe, and Rn chalcogenyl halide, salts containing the cations thereof, and salts containing the anions thereof;
(oo) A product obtained by reacting a material selected from the group consisting of water, alcohol, hydrogen sulfide and a thiol with any of the above compounds and salts thereof containing the corresponding anion;
(pp) An organic peroxide;
(qq) Water; and
(rr) Mixtures thereof,
wherein the compound is present in an amount sufficient that the molecular weight distribution of the resulting polymeric product is narrower than the polymeric product having a molecular weight distribution greater than two obtained in the absence of the compound.

2. The process according to claim 1 wherein the metal(s) of the at least one transition metal component is selected from Groups 3, 4, 5, 6, 7, 8, 9 and 10 of the Periodic Table of the Elements, as defined herein.

3. The process according to claim 2 wherein the metal is selected from the group consisting of titanium, zirconium, hafnium, vanadium, chromium and mixtures thereof.

4. The process according to claim 3 wherein the metal is selected from the group consisting of titanium, zirconium and mixtures thereof.

5. The process according to claim 1 wherein the metallocene catalyst is supported on a carrier.

6. The process according to claim 5 wherein the carrier is selected from the group consisting of silica, alumina, magnesium chloride and mixtures thereof.

7. The process according to claim 1 further comprising adding a halogenated hydrocarbon to the polymerization medium.

8. The process according to claim 1 further comprising adding at least one or more organometallic compounds to the polymerization medium.

9. The process according to claim 8 wherein the organometallic compound is an organoaluminum compound.

10. The process according to claim 9 wherein the organometallic compound is selected from the group consisting of trialkyl aluminum compounds and dialkyl aluminum monohalide compounds.

11. The process according to claim 1 wherein the compound is a nitrogen oxide selected from the group consisting of nitrogen monoxide, nitrogen dioxide, dinitrogen monoxide, dinitrogen trioxide, dinitrogen tetroxide and dinitrogen pentoxide.

12. The process according to claim 11 wherein the nitrogen oxide is dinitrogen monoxide.

13. The process according to claim 1 wherein the compound is a liquid or solid at 1 atmosphere of pressure and at 20° C. and is present in the polymerization medium in a molar ratio of compound to transition metal component(s) of the metallocene catalyst ranging from about 0.001:1 to about 100:1.

14. The process according to claim 1 wherein the compound is a gas at 1 atmosphere of pressure and at 20° C. and is present in the polymerization medium in an amount ranging from about 1 ppm by volume to about 10,000 ppm by volume.

15. A process for narrowing molecular weight distribution of a polymer comprising at least one or more olefin(s) comprising contacting under polymerization conditions, the at least one or more olefin(s) with at least one metallocene catalyst comprising at least one transition metal component having at least one moiety selected from substituted or unsubstituted cyclopentadienyl, substituted or unsubstituted pentadienyl, substituted or unsubstituted pyrrole, substituted or unsubstituted phosphole, substituted or unsubstituted arsole, substituted or unsubstituted boratabenzene, and substituted or unsubstituted carborane, and at least one co-catalyst component, and a compound selected from the group consisting of
(a) An oxide of germanium, tin and lead;
(b) Cyanogen (C₂N₂);
(c) An oxide or imide of carbon of formula CE or C₃E₂ where E=O and NR, R is hydrogen, a halogen, an alkyl group containing up to 50 non-hydrogen atoms, an aryl group containing up to 50 non-hydrogen atoms, a silyl group containing up to 50 non-hydrogen atoms, an alkoxy group containing up to 50 non-hydrogen atoms, an amino group containing up to 50 non-hydrogen atoms, a thiolato group containing up to 50 non-hydrogen atoms, or a boryl group containing up to 50 non-hydrogen atoms;
(d) A sulfur, selenium, or tellurium containing chalcogenide of carbon, silicon, germanium, tin and lead;
(e) A chalcogenide of carbon, silicon, germanium, tin and lead containing more than one chalcogen;
(f) A chalcogenide imide of carbon, silicon, germanium, tin and lead having the formula C(E)(X) where E=O, S, Se, Te, or NR; X=NR′ where R and/or R′ is hydrogen, a halogen, an alkyl group containing up to 50 non-hydrogen atoms, an aryl group containing up to 50 non-hydrogen atoms, a silyl group containing up to 50 non-hydrogen atoms, or a boryl group containing up to 50 non-hydrogen atoms;
(g) A chalcogenyl halide or imidohalide of carbon, silicon, germanium, tin and lead of the formula C(E)X₂ where E=O, S, Se, Te, and NR; R is hydrogen, a halogen, an alkyl group containing up to 50 non-hydrogen atoms, an aryl group containing up to 50 non-hydrogen atoms, a silyl group containing up to 50 non-hydrogen atoms, or a boryl group containing up to 50 non-hydrogen atoms; and X is a halogen;
(h) An elemental form of phosphorus, arsenic, antimony and bismuth;
(i) An oxide of nitrogen, phosphorus, arsenic, antimony and bismuth;
(j) A nitrogen oxoacid or salt containing the anion thereof;
(k) A halide of the formula EₙXₘ, where E is nitrogen, phosphorus, arsenic, antimony or bismuth and X is a halogen or pseudohalogen, n=1 to 10, and m=1 to 20;
(l) A chalcogenide or imide of nitrogen, phosphorus, arsenic, antimony and bismuth of the general formula EₙYₘ, where E=N, P, As, Sb, and Bi; Y=S, Se, Te and NR; n=1 to 10; m=1 to 40; and R is hydrogen, a halogen, an alkyl group containing up to 50 non-hydrogen atoms, an aryl group containing up to 50 non-hydrogen atoms, a silyl group containing up to 50 non-hydrogen atoms, or a boryl group containing up to 50 non-hydrogen atoms;
(m) A chalcogenyl or imido compound of nitrogen, phosphorus, arsenic, antimony and bismuth having the formula EₙYₘX_{q}, where E=N, P, As, Sb and Bi; Y=O, S, Se, Te and NR; X is hydrogen, a halogen, an alkyl group containing up to 50 non-hydrogen atoms, an aryl group containing up to 50 non-hydrogen atoms, a silyl group containing up to 50 non-hydrogen atoms, an alkoxy group containing up to 50 non-hydrogen atoms, an amino group containing up to 50 non-hydrogen atoms, a thiolato group containing up to 50 non-hydrogen atoms, or a boryl group containing up to 50 non-hydrogen atoms; n=1 to 20; m=1 to 40; q=1 to 40; and R is hydrogen, a halogen, an alkyl group containing up to 50 non-hydrogen atoms, an aryl group containing up to 50 non-hydrogen atoms, a silyl group containing up to 50 non-hydrogen atoms, an alkoxy group containing up to 50 non-hydrogen atoms, an amino group containing up to 50 non-hydrogen atoms, a thiolato group containing up to 50 non-hydrogen atoms, or a boryl group containing up to 50 non-hydrogen atoms;
(n) An interpnictogen;
(o) A phosphazene of the general formula (NPR₂)ₓ wherein R=halogen, or alkyl or aryl group containing up to 50 non-hydrogen atoms, and x is at least 2;
(p) A compound of the general formula A(E)X₃ where A=P, As, Sb, and Bi; E=NR or CR₂, R is hydrogen, a halogen, an alkyl group containing up to 50 non-hydrogen atoms, an aryl group containing up to 50 non-hydrogen atoms, a silyl group containing up to 50 non-hydrogen atoms, an alkoxy group containing up to 50 non-hydrogen atoms, an amino group containing up to 50 non-hydrogen atoms, a thiolato group containing up to 50 non-hydrogen atoms, or a boryl group containing up to 50 non-hydrogen atoms; and X is hydrogen, a halogen, an alkyl group containing up to 50 non-hydrogen atoms, an aryl group containing up to 50 non-hydrogen atoms, a silyl group containing up to 50 non-hydrogen atoms, an alkoxy group containing up to 50 non-hydrogen atoms, an amino group containing up to 50 non-hydrogen atoms, a thiolato group containing up to 50 non-hydrogen atoms, or a boryl group containing up to 50 non-hydrogen atoms;
(q) A pnictogen hydride;
(r) An elemental form of oxygen, sulfur, selenium, and tellurium;
(s) An interchalcogen;
(t) A compound containing one or more chalcogens and one or more halogens of formula EₙXₘ where E=O, S, Se, and Te; X is hydrogen, a halogen, an alkyl group containing up to 50 non-hydrogen atoms, an aryl group containing up to 50 non-hydrogen atoms, a silyl group containing up to 50 non-hydrogen atoms, an alkoxy group containing up to 50 non-hydrogen atoms, an amino group containing up to 50 non-hydrogen atoms, a thiolato group containing up to 50 non-hydrogen atoms, or a boryl group containing up to 50 non-hydrogen atoms, n=1 to 10, m=1 to 20;
(u) A compound of general formula EOX₂ where E=O, S, Se, and Te; X is hydrogen, a halogen, an alkyl group containing up to 50 non-hydrogen atoms, an aryl group containing up to 50 non-hydrogen atoms, a silyl group containing up to 50 non-hydrogen atoms, an alkoxy group containing up to 50 non-hydrogen atoms, an amino group containing up to 50 non-hydrogen atoms, a thiolato group containing up to 50 non-hydrogen atoms, or a boryl group containing up to 50 non-hydrogen atoms;
(v) A compound of general formula EOX₄ where E=S, Se, and Te; X is hydrogen, a halogen, an alkyl group containing up to 50 non-hydrogen atoms, an aryl group containing up to 50 non-hydrogen atoms, a silyl group containing up to 50 non-hydrogen atoms, an alkoxy group containing up to 50 non-hydrogen atoms, an amino group containing up to 50 non-hydrogen atoms, a thiolato group containing up to 50 non-hydrogen atoms, or a boryl group containing up to 50 non-hydrogen atoms;
(w) A compound of general formula EO₂X₂ where E=S, Se, and Te; X is hydrogen, a halogen, an alkyl group containing up to 50 non-hydrogen atoms, an aryl group containing up to 50 non-hydrogen atoms, a silyl group containing up to 50 non-hydrogen atoms, an alkoxy group containing up to 50 non-hydrogen atoms, an amino group containing up to 50 non-hydrogen atoms, a thiolato group containing up to 50 non-hydrogen atoms, or a boryl group containing up to 50 non-hydrogen atoms;
(x) A Sulfur-Nitrogen compound;
(y) A compound of the formula S(NR)ₙXₘ where n=1 to 3; m−0 to 6; X is hydrogen, a halogen, an alkyl group containing up to 50 non-hydrogen atoms, an aryl group containing up to 50 non-hydrogen atoms, a silyl group containing up to 50 non-hydrogen atoms, an alkoxy group containing up to 50 non-hydrogen atoms, an amino group containing up to 50 non-hydrogen atoms, a thiolato group containing up to 50 non-hydrogen atoms, or a boryl group containing up to 50 non-hydrogen atoms; and R is hydrogen, a halogen, an alkyl group containing up to 50 non-hydrogen atoms, an aryl group containing up to 50 non-hydrogen atoms, a silyl group containing up to 50 non-hydrogen atoms, an alkoxy group containing up to 50 non-hydrogen atoms, an amino group containing up to 50 non-hydrogen atoms, a thiolato group containing up to 50 non-hydrogen atoms, or a boryl group containing up to 50 non-hydrogen atoms;
(z) A sulfur oxoacid, peroxoacid, and salts containing the anions thereof;
(aa) A selenium oxoacid, peroxoacid, and salts containing the anions thereof;
(bb) A tellurium oxoacid, peroxoacid, and salts containing the anions thereof;
(cc) A chalcogen hydride;
(dd) An elemental form of fluorine, chlorine, bromine, iodine, and astatine;
(ee) An interhalogen, salts containing their cations, and salts containing the anions thereof;
(ff) A salt containing polyhalide cations and/or anions;
(gg) A homoleptic or heteroleptic halogen oxide, salts containing the cations thereof, and salts containing the anion thereof;
(hh) An oxoacid and salts containing the anions thereof;
(ii) A hydrogen halide;
(jj) NH₄F, SF₄, SbF₃, AgF₂, KHF₂, ZnF₂, AsF₃, and salts containing the HF₂⁻ anion;
(kk) A hydrohalic acid;
(ll) A He, Ne, Ar, Kr, Xe, and Rn oxide, salts containing the cations thereof, and salts containing the anions thereof;
(mm) A He, Ne, Ar, Kr, Xe, and Rn halide, salts containing the cations thereof, and salts containing the anions thereof;
(nn) A He, Ne, Ar, Kr, Xe, and Rn chalcogenyl halide, salts containing the cations thereof, and salts containing the anions thereof;
(oo) A product obtained by reacting a material selected from the group consisting of water, alcohol, hydrogen sulfide and a thiol with any of the above compounds and salts thereof containing the corresponding anion;
(pp) An organic peroxide;
(qq) Water; and
(rr) Mixtures thereof,
wherein the compound is present in an amount sufficient that the molecular weight distribution of the resulting polymeric product is narrower than would be obtained in the absence of the compound.

16. The process according to claim 15 wherein the metal(s) of the at least one transition metal component is selected from Groups 3, 4, 5, 6, 7, 8, 9 and 10 of the Periodic Table of the Elements, as defined herein.

17. The process according to claim 16 wherein the metal is selected from the group consisting of titanium, zirconium, hafnium, vanadium, chromium and mixtures thereof.

18. The process according to claim 17 wherein the metal is selected from the group consisting of titanium, zirconium and mixtures thereof.

19. The process according to claim 15 wherein the metallocene catalyst is supported on a carrier.

20. The process according to claim 19 wherein the carrier is selected from the group consisting of silica, alumina, magnesium chloride and mixtures thereof.

21. The process according to claim 15 further comprising adding a halogenated hydrocarbon to the polymerization medium.

22. The process according to claim 15 further comprising adding at least one or more organometallic compounds to the polymerization medium.

23. The process according to claim 22 wherein the organometallic compound is an organoaluminum compound.

24. The process according to claim 23 wherein the organometallic compound is selected from the group consisting of trialkyl aluminum compounds and dialkyl aluminum monohalide compounds.

25. The process according to claim 15 wherein the compound is a nitrogen oxide selected from the group consisting of nitrogen monoxide, nitrogen dioxide, dinitrogen monoxide, dinitrogen trioxide, dinitrogen tetroxide and dinitrogen pentoxide.

26. The process according to claim 25 wherein the nitrogen oxide is dinitrogen monoxide.

27. The process according to claim 15 wherein the compound is a liquid or solid at 1 atmosphere of pressure and at 20° C. and is present in the polymerization medium in a molar ratio of compound to transition metal component(s) of the metallocene catalyst ranging from about 0.001:1 to about 100:1.

28. The process according to claim 15 wherein the compound is a gas at 1 atmosphere of pressure and at 20° C. and is present in the polymerization medium in an amount ranging from about 1 ppm by volume to about 10,000 ppm by volume.

29. The process according to claim 1 wherein the polymerization conditions are gas phase.

30. The process according to claim 1 wherein the polymerization conditions are solution phase.

31. The process according to claim 1 wherein the polymerization conditions are slurry phase.

32. The process according to claim 1 wherein at least one olefin is ethylene.

33. A film fabricated from the polymeric product according to claim 1.

34. An article fabricated from the polymeric product according to claim 1.
